(19) United States
(12) Patent Application Publication
(10) Pub. No.: US 2016/0088262 A1
(43) Pub. Date: Mar. 24, 2016

(54) Method For Managing Storage Product In Refrigerator Using Image Recognition, And Refrigerator For Same

(71) Applicant: LG ELECTRONICS INC., Seoul (KR)

(72) Inventors: Jungho LEE, Seoul (KR); Jeongsuk YOON, Seoul (KR); Seungmin BAEK, Seoul (KR)

(21) Appl. No.: 14/783,612

(22) PCT Filed: Apr. 10, 2013
(86) PCT No.: PCT/KR2013/002995

§ 371 Date: Oct. 9, 2015

(51) Int. Cl. H04N 7/18; G06K 9/62; G06F 3/16

(52) U.S. Cl. CPC H04N 7/183; G06F 3/167; G06K 9/6232

(57) ABSTRACT

A refrigerator is provided. The refrigerator includes an imaging unit generating a goods loading/unloading video through video recording of storage goods loaded into or unloaded from the refrigerator; a data storage unit storing the goods loading/unloading video, goods information that may be stored in the refrigerator, and storage items information; a control unit recognizing loading/unloading of goods based on an optical flow detected through vision recognition from the goods loading/unloading video, and updating the storage items information in the refrigerator based on recognition information generated through vision recognition on loading/unloading of the goods and the goods information stored in the data storage unit; and a display unit displaying a managed state of storage items for a user based on the updated storage items information.

### TECHNICAL FIELD

The present disclosure relates to a method of managing storage items in a refrigerator using image recognition and a refrigerator, and more particularly, to a method of managing storage items in a refrigerator using image recognition and a refrigerator that recognize the loading/unloading of storage goods into or from the refrigerator by using an image recognition technology on an image obtained from a camera which is installed in the refrigerator.

### BACKGROUND ART

A refrigerator is a means for storing food at a low temperature to prevent the food from decaying but the breeding activity of bacteria does not completely stop. Thus, when the food is stored in the refrigerator, the preservation period of the food becomes longer in comparison to when the food is not stored in the refrigerator and it is difficult to completely protect the food from decaying.

Since a time when the food is loaded into the refrigerator is typically different for each food when the food is stored in the refrigerator and it is difficult to find the accurate position of many stored foods, there is a limitation in that the storage period of the foods becomes longer or it is difficult to find how many days have elapsed after the storage.

Also, some functions have been introduced which enable a user to write items stored in the refrigerator and their expiry dates by using a keypad/touch pad when the user loads any food in the refrigerator and provide information based on the written data or simply monitor the inside of the refrigerator from the outside.

However, it has many weak points in an aspect of user convenience. Also, when a food is loaded/unloaded without an input or correction, a case where the items stored in the refrigerator are different from provided information may frequently occur.

### DISCLOSURE OF THE INVENTION

### Technical Problem

Embodiments provide a method of managing storage items in a refrigerator using image recognition and a refrigerator that may automatically recognize and register/delete/correct when a user loads/unloads items including various foods into or from the refrigerator, enable the user to register by using voice, a touch pad, a keypad, etc. which item the user may not recognize so that it is possible to provide accurate information and also increase user convenience.

### Technical Solution

In one embodiment, a refrigerator includes an imaging unit generating a goods loading/unloading video through video recording of storage goods loaded into or unloaded from the refrigerator; a data storage unit storing the goods loading/unloading video, goods information that may be stored in the refrigerator, and storage items information; a control unit recognizing loading/unloading of goods based on an optical flow detected through vision recognition from the goods loading/unloading video, and updating the storage items information in the refrigerator based on recognition information generated through vision recognition on loading/unloading of the goods and the goods information stored in the data storage unit; and a display unit displaying a managed state of storage items for a user based on the updated storage items information.

The refrigerator may further include a voice input unit obtaining voice information capable of being generated upon loading and unloading of goods and voice information generated by a user for management of goods.

The control unit may include a loading/unloading recognition unit detecting the optical flow through vision recognition on the goods loading/unloading video generated by the imaging unit, and recognizing the loading/unloading of goods through the detected optical flow; an object region detection unit detecting an object region from the goods loading/unloading video; a characteristic extraction unit extracting a characteristic point of a corresponding object from the object region detected; and a storage item management unit updating the storage items information in the refrigerator based on recognition information on the loading/unloading of goods, characteristic point information on the extracted characteristic point, and the stored goods information, and managing the updated storage items information.

The loading/unloading recognition unit may detect a motion vector for goods from the goods loading/unloading video through the detected optical flow, and recognize the loading/unloading of corresponding goods based on the detected motion vector.

The object region detection unit may capture the goods loading/unloading video when the loading/unloading of goods is recognized, and calculate a difference between a captured frame and a pre-stored background image to separately detect a user's arm and a region that an object occupies.

The object region detection unit may accumulate, by using a Gaussian model, each frame of an image obtained by the imaging unit to obtain an average background image to generate the pre-stored background image.

The characteristic extraction unit may extract a characteristic of goods from a region separated from the image captured from the goods loading/unloading video, and perform goods recognition through a search from a local DB stored in the refrigerator or a global DB provided from outside of the refrigerator based on the extracted characteristic of goods.

The storage goods management unit may update the storage items based on recognized goods information divided into a local DB stored in the refrigerator and a global DB provided from outside of the refrigerator and goods information by a user input.

The storage goods management unit may receive a user input for goods not recognized through the image recognition, determine corresponding goods information and update the storage items.

The storage goods management unit may search for based on a direction model of a pre-stored image patch to which category a characteristic of a goods image belongs, and store a category of a characteristic that corresponding goods have and a geometric position relationship.

In another embodiment, a method of managing storage items in a refrigerator using image recognition includes generating a goods loading/unloading video through video recording of storage goods loaded into or unloaded from a refrigerator; recognizing loading/unloading of goods through vision recognition from the goods loading/unloading video, and updating pre-stored storage items information in the refrigerator based on recognition information generated through vision recognition on the loading/unloading of the goods and pre-stored goods information; and displaying a managed state of storage items for a user based on the updated storage items information.

The method may further include accumulating and storing the generated video; and performing background modeling of a video based on the accumulated and stored video.

The performing of the background modeling of the video may include determining a background region excluding storage goods in the refrigerator and hands from the stored video.

The background modeling may determine the background region through comparison between image frames based on video information accumulated in the data storage unit.

The updating the pre-stored storage items information may include recognizing the loading/unloading of goods through vision recognition from the goods loading/unloading video to generate recognition information; separating an object region from the goods loading/unloading video based on the generated recognition information; extracting a characteristic point of corresponding goods from the separated object region based on the stored goods information; and updating the pre-stored storage items information in the refrigerator based on the recognition information on the loading/unloading of goods, characteristic point information on the extracted characteristic point, and the stored goods information, and managing the updated information.

The generating of the recognition information may include detecting an optical flow through vision recognition on the video generated by the imaging unit; detecting a motion vector for goods from the video through the detected optical flow; and recognizing loading/unloading of corresponding goods based on the detected motion vector.

The extracting of the characteristic point of the goods may include extracting a pre-stored characteristic of goods from an object when searching for goods, extracting a group of candidates according to how much the extracted characteristic has a characteristic of a similar category, and then determines a result of recognition by using a geometric position relationship of each characteristic.

The method according may further include providing information on the storage items and numbers stored in the refrigerator, and notification information to a device outside the refrigerator, a portable device, or e-mail to allow a user to check corruption of goods stored for a certain period.

The method may further include displaying user's usage statistics for each storage item and position information on goods in the refrigerator, for a user.

The method may further include providing inventory information on goods in the refrigerator to an external device that enables users to do shopping.

### Advantageous Effects

According to the present disclosure, it is possible to recognize the loading/unloading of storage items through video recording and vision recognition on storage items including various foods loaded into/unloaded from a refrigerator.

Thus, there is no need for an additional job to be performed by a user for managing the loading/unloading of storage items in the refrigerator. That is, since a typical inconvenient procedure in which a user should bring or register goods into contact with a barcode reader one by one is omitted, user convenience may increase.

Also, since determination on whether any storage item has been loaded into or unloaded from the refrigerator is automatically made through vision recognition, not by user's registration, the storage goods in the refrigerator may be accurately managed.

According to the present disclosure, it is possible to check information on various storage items including foods managed by the refrigerator and it is possible to efficiently manage foods according to the checked information.

Also, according to the present disclosure, it is possible to manage various storage items including foods by using a local DB. Since significantly many kinds of foods may be stored in the refrigerator but the number of foods that may be actually stored in one refrigerator is about 100, the usage of the local DB may enhance the speed and accuracy of food recognition when loading/unloading is performed.

### BRIEF DESCRIPTION OF THE DRAWINGS

FIG. 1 is a block diagram of a refrigerator that performs a method of managing the storage items of the refrigerator using image recognition according to an embodiment.

FIG. 2 is a block diagram for explaining the control unit of a refrigerator according to an embodiment.

FIG. 3 is a flowchart of a method of managing goods in a refrigerator using image recognition according to an embodiment.

FIG. 4 is a flowchart of a method of managing goods in a refrigerator using image recognition according to an embodiment.

FIG. 5 is a flowchart of a method of managing goods in a refrigerator using image recognition according to an embodiment.

### MODE FOR CARRYING OUT THE INVENTION

In the following, embodiments are described in detail with reference to the accompanying drawings. The following embodiments are provided as examples for fully conveying the spirit of the present disclosure to a person skilled in the art. Thus, the present disclosure may not be limited to the following embodiments and may also be implemented in other forms. In addition, the width, length, and thickness of components in the drawings may be exaggerated for convenience. The same reference numerals represent the same components throughout the disclosure. Since the suffixes “module” and “unit” for components used in the following description are given and interchanged for easiness in making the present disclosure, they do not have distinct meanings or functions.

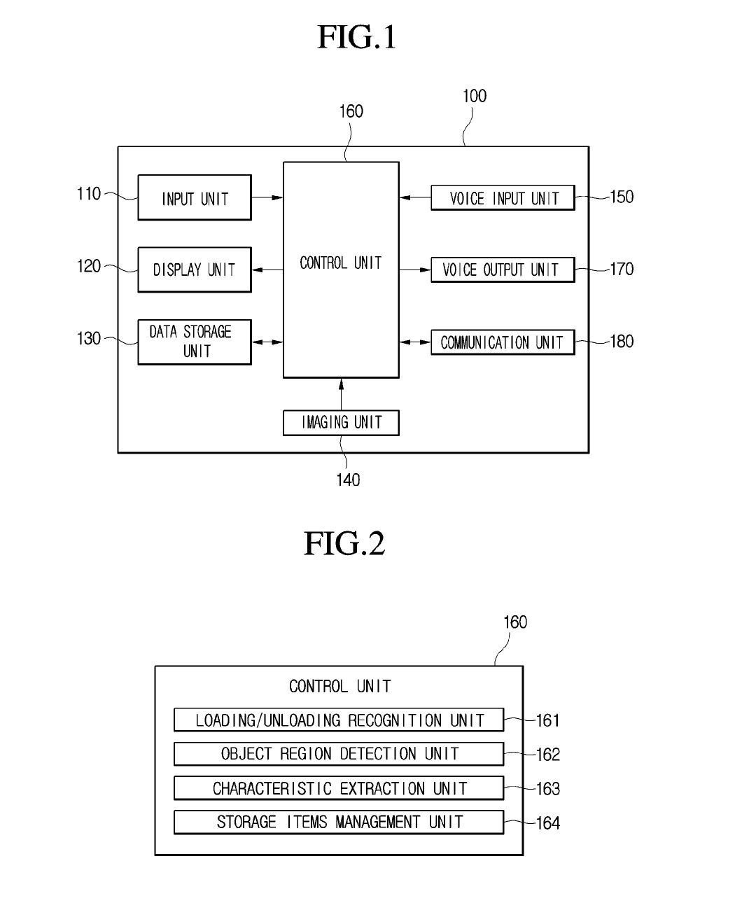

FIG. 1 is a block diagram of a refrigerator that performs a method of managing storage items in the refrigerator using image recognition according to an embodiment.

Referring to FIG. 1, a refrigerator 100 according to an embodiment may include an input unit 110, a display unit 120, a data storage unit 130, an imaging unit 140, a voice input unit 150, a control unit 160, a voice output unit 170, and a communication unit 180.

The input unit 110 is an input device for receiving a user's command for the management of storage items in a refrigerator. For example, the input unit 130 may include a touch panel or keypad.

The display unit 120 may display information on the storage items. The display unit 120 may display information on various goods stored in the refrigerator or goods management information. The display unit 120 may display, for a user, details recognized on goods/check and inquiry for recognition check/details input by a user/retaining goods information/DB details.

The data storage unit 130 may store goods information. The goods information may include information on goods themselves (goods information) and information on the management of goods (goods management information).

The goods information may include e.g., a type of goods, the name of goods, the shape of goods or the weight of goods, and the goods management information may include e.g., the storage position, an amount of storage, a storage period, or a loading/unloading history of goods.

The data storage unit 130 may include a global DB and a local DB. The global DB may store images of industrial products and fruits/vegetables in the market and data on the images characteristics.

The local DB may store an image obtained by imaging goods in the refrigerator and data including the characteristic of a corresponding image or an image obtained by imaging the inside of the refrigerator and a list of goods. Also, even when there is data on corresponding goods in the global DB, the local BD may also store it.

The imaging unit 140 may obtain images of goods through video recording of goods loaded into/unloaded from the refrigerator 100. The imaging unit 140 may include one or more cameras inside or outside the refrigerator in order to obtain a still image as well as video.

Regions imaged by the imaging unit 140 may include the fresh compartment (for fruits/vegetables), ordinary compartment, door compartment, and freezing compartment inside the refrigerator and the outside of the refrigerator. The images obtained by the imaging unit 140 may be used for recognizing loading into or unloading from the refrigerator of any goods.

The voice input unit 150 may obtain voice information capable of being provided upon the loading/unloading of goods and voice information generated by a user for the management of goods.

The voice input unit 150 may obtain a voice command input from the user in order to set information on goods upon the loading/unloading of goods. For example, the voice input unit 150 may include a directional microphone installed in the refrigerator.

User's voice information obtained through the voice input unit 150 may be used for the check and correction of a user for the goods recognized by the imaging unit 140.

Also, the user's voice information obtained by the voice input unit 150 may be used for inputting information on goods that are not included in the global DB and the local DB.

The control unit 160 may extract a goods region from the image obtained by the imaging unit 110 and extract the characteristic of goods from the extracted goods region.

The control unit 160 compares the extracted image with goods information in the data storage unit 130 to perform recognition on the goods.

Also, the control unit 160 may compare the images of the refrigerator obtained before and after the door of the refrigerator opens, search for a region having a change from the images of the refrigerator and sense the loading/unloading or position change of goods. Also, the control unit 160 may recognize a user voice command input to the voice input unit 120 to convert the recognized command into characters.

The communication unit 180 may transmit data required when the user searches for data by using an external device or when notification information on the items of goods which has been stored in the refrigerator 100 for a certain period and requires a check on whether the goods have been corrupted is transmitted to an external device.

A method of managing goods using image recognition on a refrigerator in the refrigerator having such a configuration is as follows.

When the door of the refrigerator opens, the imaging unit 140 starts video recording. The imaging unit 140 continuously accumulates video to make a background. The video may be later used for separating an object region.

The control unit 160 may use an optical flow from the video obtained by the imaging unit 120 to continuously scan the direction of a moving pixel.

The control unit 160 may recognize through a result of scan that a user's arm enters and then leaves the refrigerator.

When a loading/unloading event occurs, the control unit 160 may use the video of a corresponding scene and the previously made background model to separate a user's arm region from goods. The control unit 160 may extract a characteristic from the separated region to store the extracted characteristic in the local DB or search for the characteristic from the local DB or the global DB.

The name of goods loaded into or unloaded from the refrigerator may be designated by using voice recognition on voice obtained by the voice input unit 150 or a user input that is input by the input unit 110.

The control unit 160 may detect a motion vector from the video to recognize the loading or unloading of goods. The control unit 160 may detect the motion vector through the optical flow when there is a motion of goods in the video.

The control unit 160 may use the fact that the directions of dominant motion vectors are opposite when the user's arm enters or leaves the refrigerator in order to load or unload goods into or from the refrigerator 100.

To this end, the control unit 160 may simulate the direction of the motion vector and an amount of the motion vector relative to the entire screen and set a critical value based on a result of the simulation. The control unit 160 may find out based on the set critical value whether goods are loaded/unloaded.

The control unit 160 may separate and detect an object region from an image.

The separation of the object region is a technology using what a portion where there is a little motion may be identified as a background when each frame of the video is continuously accumulated.

That is, the control unit 160 may accumulate, by using a Gaussian model, each frame of an image obtained by the imaging unit 140 to obtain an average background image.

Then, the control unit 160 may calculate a difference between a frame captured when the loading/unloading of goods is recognized and an obtained background image, to approximately find regions that the user's arm and goods occupy.

Also, since the control unit 160 may approximately find the position of an arm by using an edge image, it is possible to separate a goods region.

The control unit 160 may extract the characteristic of goods from the separated goods region.

Since goods loaded into/unloaded from the refrigerator 100 vary, the control unit 160 should use the strong characteristic of goods for goods recognition.

For example, a corner point, SIFT, SURE, MSER, etc. may be used as a reference point extraction method resistant to the variation of goods. These reference point extraction methods are methods modified from detecting a point that the Laplacian of Gaussian is invariable.

When a corresponding point is detected for image recognition, the control unit 160 should store the descriptor of a surrounding region, in which case it is possible to use an image patch, an edge histogram, a color, a texture pattern, an extremal region shape, etc.

In this case, the control unit 160 may use the direction model of the image patch as the characteristic and it is possible to train most characteristics that may be in a daily life, by using a K-D tree structure.

Also, by such a train process, the control unit 160 may quickly search for to which category the characteristic of a goods image belongs, and store the category of a characteristic that corresponding goods have and a geometric position relationship to form a DB.

The control unit 160 may extract the characteristic of goods stored in the data storage unit 130 from an object when searching for goods, extract a group of candidates from the DB according to how much the extracted characteristic has the characteristic of a similar category, and then determine a result of recognition by using the geometric position relationship of each characteristic.

In this case, a goods management function in the refrigerator 100 may be implemented to be a stand alone or server based function.

The stand alone function refers to independently implementing, by the refrigerator, the processes of recognizing loading and unloading, separating a goods region, extracting and recognizing complicated characteristics from the goods image from which a region has been removed, in a state which the input unit 110, the display unit 120, the data storage unit 130, the imaging unit 140, the voice input unit 150, the control unit 160, the voice output unit 170, and the communication unit 180 are all implemented in the refrigerator.

The server based function refers to implementing, by the refrigerator, the processes of recognizing loading and unloading and separating a goods region and implementing, by a server, the processes of extracting and recognizing complicated characteristics from the separated goods image in a state which the input unit 110, the display unit 120, the data storage unit 130, the imaging unit 140, the voice input unit 150, the control unit 160, the voice output unit 170, and the communication unit 180 are all implemented in the refrigerator.

FIG. 2 is a block diagram for explaining the control unit of a refrigerator according to an embodiment.

Referring to FIG. 2, the control unit 160 of the refrigerator according to an embodiment may include a loading/unloading recognition unit 161, an object region detection unit 162, a characteristic extraction unit 163, and a storage item management unit 164.

The loading/unloading recognition unit 161 may detect an optical flow through vision recognition on a video generated by the imaging unit 140. The loading/unloading recognition unit 161 recognizes the loading/unloading of goods through the detected optical flow.

The loading/unloading recognition unit 161 may detect a motion vector for goods from a video through the detected optical flow. The loading/unloading recognition unit 161 may recognize the loading/unloading of corresponding goods based on the detected motion vector.

The object region detection unit 162 detects an object region from a goods loading/unloading video.

The object region detection unit 162 may capture a loading/unloading video when the loading/unloading of goods is recognized. The object region detection unit 162 may calculate a difference between a captured frame and a pre-stored background image to separately detect a user's arm and a region that an object occupies.

The object region detection unit 162 may accumulate, by using a Gaussian model, each frame of an image obtained by the imaging unit 140 to obtain an average background image to generate a pre-stored background image.

The characteristic extraction unit 163 extracts, from the object region detected by the object region detection unit 162, the characteristic point of a corresponding object.

The characteristic extraction unit 163 may extract the characteristic of goods from a region separated from the image captured from the loading/unloading video.

The characteristic extraction unit 163 may perform goods recognition through a search from the local DB stored in the refrigerator or the global DB provided from the outside of the refrigerator based on the extracted characteristic of goods.

The storage item management unit 164 updates storage items information on the refrigerator based on recognition information on the loading/unloading of goods, characteristic point information on the extracted characteristic point, and stored goods information and manages the updated information.

The storage goods management unit 164 may update storage items based on recognized goods information divided into the local DB stored in the refrigerator and the global DB provided from the outside of the refrigerator and goods information by a user input.

The storage goods management unit 164 may receive a user input for goods not recognized through image recognition, determine corresponding goods information and update storage items.

The storage goods management unit 164 may search for, based on the direction model of a pre-stored image patch, to which category the characteristic of a goods image belongs. The storage goods management unit 164 may store the category of a characteristic that corresponding goods have and a geometric position relationship.

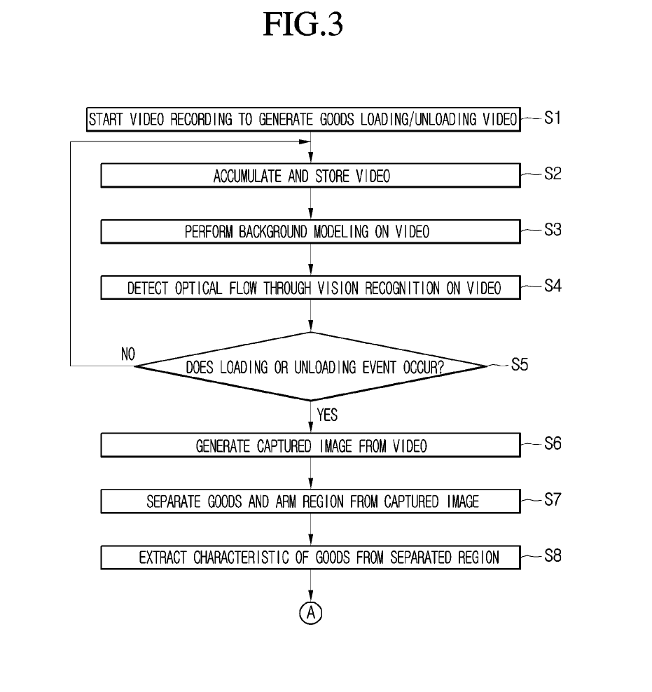

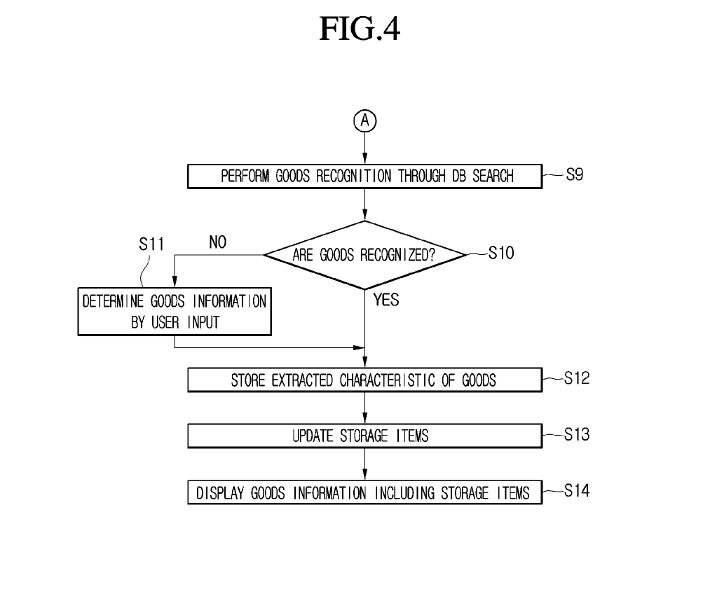

FIGS. 3 and 4 are flowcharts of a method of managing goods in a refrigerator using image recognition according to an embodiment.

Referring to FIGS. 3 and 4, the imaging unit 140 starts video recording to generate a goods loading/unloading video when it is sensed that the door of the refrigerator 100 opens, in step S1.

The control unit 160 accumulates and stores the video generated by the imaging unit 140 in the data storage unit 130, in step S2.

The control unit 160 performs the background modeling of a video based on the video accumulated and stored in the data storage unit 130, in step S3. The background modeling is a process of determining a background region excluding goods in the refrigerator 100 and hands from the video stored in the data storage unit 130. The background modeling determines the background region through comparison between image frames based on accumulated video information.

The control unit 160 detects an optical flow through vision recognition on the video generated by the imaging unit 140, in step S4. The detection of the optical flow by the control unit 160 may be performed through a continuous scan for the direction of a pixel that moves in the video. The control unit 160 may recognize through a result of a video scan that a user's arm enters and then leaves the refrigerator for the loading and unloading of goods.

The control unit 160 may detect a motion vector from the video to recognize the loading or unloading of goods. The control unit 160 may detect the motion vector through the optical flow when there is a motion of goods in the video.

The control unit 160 may use the fact that the directions of dominant motion vectors are opposite when the user's arm enters or leaves the refrigerator in order to load or unload goods into or from the refrigerator 100.

To this end, the control unit 160 may simulate the direction of the motion vector and an amount of the motion vector relative to the entire screen and set a critical value based on a result of the simulation. The control unit 160 may find out based on a set critical value whether goods are loaded/unloaded.

The control unit 160 determines based on a result of the optical flow detection whether a goods loading or unloading event for the refrigerator has occurred, in step S5.

When it is determined that the loading or unloading event has occurred, the control unit 160 captures a video at a corresponding time to generate captured images and store the generated images in the data storage unit 130, in step S6.

The control unit 160 separates goods and user's arm regions from the captured images generated by the occurrence of the loading or unloading event, in step S7. Separating an object region from an image may be performed by using background information pre-stored in the data storage unit 130, like when separating the goods and user's arm regions from the captured image.

The separation of the object region is a technology using what a portion where there is a little motion may be identified as a background when each frame of the video is continuously accumulated.

That is, the control unit 160 may accumulate, by using a Gaussian model, each frame of an image obtained by the imaging unit 140 to obtain an average background image.

Then, the control unit 160 may calculate a difference between a frame captured when the loading/unloading of goods is recognized and an obtained background image, to approximately find regions that the user's arm and goods occupy.

Also, since the control unit 160 may approximately find the position of an arm by using an edge image, it is possible to separate a goods region.

The control unit 160 may extract the characteristic of goods from the separated goods region.

Since goods loaded into/unloaded from the refrigerator 100 vary, the control unit 160 should use the strong characteristic of goods for goods recognition.

For example, a corner point, SIFT, SURE, MSER, etc. may be used as a reference point extraction method resistant to the variation of goods. These reference point extraction methods are methods modified from detecting a point that the Laplacian of Gaussian is invariable.

When a corresponding point is detected for image recognition, the control unit 160 should store the descriptor of a surrounding region, in which case it is possible to use an image patch, an edge histogram, a color, a texture pattern, an extremal region shape, etc.

In this case, the control unit 160 may use the direction model of the image patch as the characteristic and it is possible to train most characteristics that may be in a daily life, by using a K-D tree structure.

Also, by such a train process, the control unit 160 may quickly detect to which category the characteristic of a goods image belongs, and store the category of a characteristic that corresponding goods have and a geometric position relationship to form a DB.

The control unit 160 extracts the characteristic of goods from a region separated from the captured image in step S8.

The control unit 160 performs goods recognition through a search from the local DB or the global DB based on the extracted characteristic of goods in step S9.

The goods recognition is performed by searching for whether there is goods information that has a characteristic matching the characteristic of goods extracted from the local DB or the global DB. In this case, the match means coincidence within a set range.

The control unit 160 may extract the characteristic of goods stored in the data storage unit 130 from an object when searching for goods, extract a group of candidates from the DB according to how much the extracted characteristic has the characteristic of a similar category, and then determine a result of recognition by using the geometric position relationship of each characteristic.

The control unit 160 determines whether goods recognition is successful, according to whether there is goods information matching the extracted characteristic of goods in the local DB or the global DB, in step S10.

When there is goods information matching the extracted characteristic of goods in the local DB or the global DB, the control unit 160 determines that goods recognition is successful, and when negative, the control unit determines that goods recognition has failed.

The control unit 160 receives a user input for goods not recognized and determines corresponding goods information, in step S11. For example, the name of goods loaded into or unloaded from the refrigerator may be designated by using voice recognition on voice obtained by the voice input unit 150 or a user input that is input by the input unit 110.

The control unit 160 stores the extracted characteristic of goods for recognized goods or goods designated by the user input in the data storage unit 160, in step S12.

The control unit 160 updates storage items based on recognized goods information divided into the local DB and the global DB and the goods information by the user input, in step S13.

The control unit 160 displays goods information including the updated storage items on the display unit 120, in step S14.

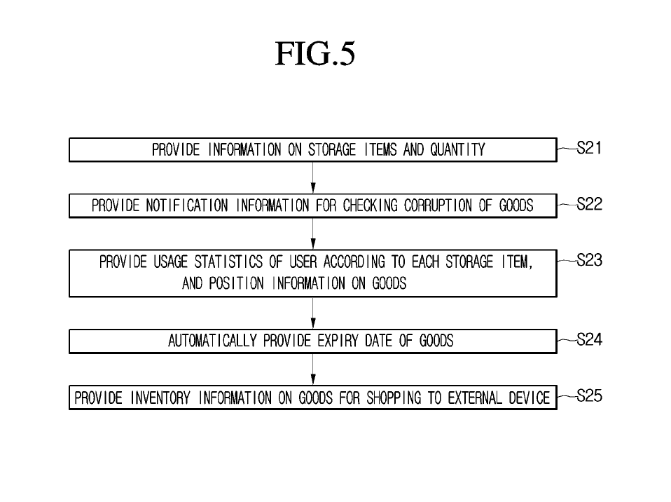

FIG. 5 is a flowchart of a method of managing goods in a refrigerator using image recognition according to an embodiment.

Referring to FIG. 5, the control unit 160 may provide information on storage items and numbers currently stored in the refrigerator after the storage items in the refrigerator have been updated by using refrigerator image recognition, in step S21.

The control unit 160 may automatically provide notification information to a device outside the refrigerator, a portable device, or e-mail so that a user may check the corruption of goods stored for a certain period, in step S22.

Also, the control unit 160 may also provide user's usage statistics for each storage item or provide position information on goods in the refrigerator on the display unit 120, in step S23.

In addition, the control unit 160 may automatically provide the expiry date of goods easy to be corrupted, such as fruits or vegetables, in step S24.

Also, the control unit 160 may provide inventory information on goods in the refrigerator to an external device, such as a smart phone to be used when users do the shopping, in step S25.

Although particular embodiments have been described above, many various may also be implemented without departing from the scope of the present disclosure. Therefore, the scope of the present disclosure should not be limited to the above-described embodiments but should be defined by equivalents to the following claims as well as the following claims.

1. A refrigerator comprising:
an imaging unit generating a goods loading/unloading video through video recording of storage goods loaded into or unloaded from the refrigerator;
a data storage unit storing the goods loading/unloading video, goods information that may be stored in the refrigerator, and storage items information;
a control unit recognizing loading/unloading of goods based on an optical flow detected through vision recognition from the goods loading/unloading video, and updating the storage items information in the refrigerator based on recognition information generated through vision recognition on loading/unloading of the goods and the goods information stored in the data storage unit; and
a display unit displaying a managed state of storage items for a user based on the updated storage items information.

2. The refrigerator according to claim 1, further comprising a voice input unit obtaining voice information capable of being generated upon loading and unloading of goods and voice information generated by a user for management of goods.

3. The refrigerator according to claim 1, wherein the control unit comprises:
a loading/unloading recognition unit detecting the optical flow through vision recognition on the goods loading/unloading video generated by the imaging unit, and recognizing the loading/unloading of goods through the detected optical flow;
an object region detection unit detecting an object region from the goods loading/unloading video;
a characteristic extraction unit extracting a characteristic point of a corresponding object from the object region detected; and
a storage item management unit updating the storage items information on the refrigerator based on recognition information on the loading/unloading of goods, characteristic point information on the extracted characteristic point, and the stored goods information, and managing the updated storage items information.

4. The refrigerator according to claim 3, wherein the loading/unloading recognition unit detects a motion vector for goods from the goods loading/unloading video through the detected optical flow, and recognizes the loading/unloading of corresponding goods based on the detected motion vector.

5. The refrigerator according to claim 3, wherein the object region detection unit captures the goods loading/unloading video when the loading/unloading of goods is recognized, and calculates a difference between a captured frame and a pre-stored background image to separately detect a user's arm and a region that an object occupies.

6. The refrigerator according to claim 5, wherein the object region detection unit accumulates, by using a Gaussian model, each frame of an image obtained by the imaging unit to obtain an average background image to generate the pre-stored background image.

7. The refrigerator according to claim 3, wherein the characteristic extraction unit extracts a characteristic of goods from a region separated from the image captured from the goods loading/unloading video, and performs goods recognition through a search from a local DB stored in the refrigerator or a global DB provided from outside of the refrigerator based on the extracted characteristic of goods.

8. The refrigerator according to claim 3, wherein the storage goods management unit updates the storage items based on recognized goods information divided into a local DB stored in the refrigerator and a global DB provided from outside of the refrigerator and goods information by a user input.

9. The refrigerator according to claim 1, wherein the storage goods management unit receives a user input for goods not recognized through the image recognition, determines corresponding goods information and updates the storage items.

10. The refrigerator according to claim 1, wherein the storage goods management unit searches for based on a direction model of a pre-stored image patch to which category a characteristic of a goods image belongs, and stores a category of a characteristic that corresponding goods have and a geometric position relationship.

11. A method of managing storage items in a refrigerator using image recognition, the method comprising:
generating a goods loading/unloading video through video recording of storage goods loaded into or unloaded from the refrigerator;
recognizing loading/unloading of goods through vision recognition from the goods loading/unloading video, and updating pre-stored storage items information in the refrigerator based on recognition information generated through vision recognition on the loading/unloading of the goods and pre-stored goods information; and
displaying a managed state of storage items for a user based on the updated storage items information.

12. The method according to claim 11, further comprising:
accumulating and storing the generated video; and
performing background modeling of a video based on the accumulated and stored video.

13. The method according to claim 12, wherein the performing of the background modeling of the video comprises determining a background region excluding storage goods in the refrigerator and hands from the stored video.

14. The method according to claim 13, wherein the background modeling determines the background region through comparison between image frames based on video information accumulated in the data storage unit.

15. The refrigerator according to claim 11, wherein the updating the pre-stored storage items information comprises:
recognizing the loading/unloading of goods through vision recognition from the goods loading/unloading video to generate recognition information;
separating an object region from the goods loading/unloading video based on the generated recognition information;
extracting a characteristic point of corresponding goods from the separated object region based on the stored goods information; and
updating the pre-stored storage items information in the refrigerator based on the recognition information on the loading/unloading of goods, characteristic point information on the extracted characteristic point, and the stored goods information, and managing the updated information.

16. The method according to claim 15, wherein the generating of the recognition information comprises:
detecting an optical flow through vision recognition on the video generated by the imaging unit;
detecting a motion vector for goods from the video through the detected optical flow; and
recognizing loading/unloading of corresponding goods based on the detected motion vector.

17. The method according to claim 15, wherein the extracting of the characteristic point of the goods comprises extracting a pre-stored characteristic of goods from an object when searching for goods, extracting a group of candidates according to how much the extracted characteristic has a characteristic of a similar category, and then determines a result of recognition by using a geometric position relationship of each characteristic.

18. The method according to claim 11, further comprising providing information on the storage items and numbers stored in the refrigerator, and notification information to a device outside the refrigerator, a portable device, or e-mail to allow a user to check corruption of goods stored for a certain period.

19. The method according to claim 11, further comprising displaying user's usage statistics for each storage item and position information on goods in the refrigerator, for a user.

20. The method according to claim 11, further comprising providing inventory information on goods in the refrigerator to an external device that enables users to do shopping.
